(19) United States
(12) Patent Application Publication
(10) Pub. No.: US 2017/0031763 A1
(43) Pub. Date: Feb. 2, 2017

(54) HYBRID PARITY INITIALIZATION

(71) Applicant: Futurewei Technologies, Inc., Plano, TX (US)

(72) Inventor: Weimin Pan, Spring, TX (US)

(21) Appl. No.: 14/810,927

(22) Filed: Jul. 28, 2015

(51) Int. Cl. G06F 11/10; G06F 3/06

(52) U.S. Cl. CPC G06F 11/1096; G06F 3/0619; G06F 3/064; G06F 3/0689

(57) ABSTRACT

A method includes determining, via a controller, of an array of storage devices that includes parity which has not been initialized, if a stripe of the array in use has been written by checking a table stored on a storage device that indicates if the stripe has been written, performing, via the controller, an XOR based parity initialization of the stripe if the stripe has been written, and performing, via the controller, a zero based parity initialization of the stripe if the stripe has not been written.

### BACKGROUND

For a RAID (redundant array of inexpensive/independent disk drives) controller, data on the drives is usually initialized into a known state so that data can be recovered in the event of a disk drive failure. This is sometimes referred to as background initialization, and does not erase user data, but does ensure parity is correct.

Some RAID levels should be initialized for best performance. When a RAID system is created, a foreground initialization (write zero based) may be used to initialize the drives. Such an initialization will take place before the system is used (seen and used by an operating system), or a background initialization (exclusive or (XOR) based) may be used, which allows the system to be used immediately, but will slow down the unit performance until initialization completes.

Initialization makes parity information valid. Foreground initialization does this by simply writing zeroes to all the drives so that they all have the same values, overwriting any existing data in the process. In contrast, background initialization uses a XOR algorithm to initialize the parity information on the drives and does not rewrite existing data.

### SUMMARY

A method includes determining, via a controller, of an array of storage devices that includes parity which has not been initialized, if a stripe of the array in use has been written by checking a table stored on a storage device that indicates if the stripe has been written, performing, via the controller, an XOR based parity initialization of the stripe if the stripe has been written, and performing, via the controller, a zero based parity initialization of the stripe if the stripe has not been written.

In further embodiments, the method may optionally include one or more of the following examples in various combinations. One example includes locking the stripe while performing parity initialization of the stripe and delaying write commands from a host until the parity initialization is complete. In another example, the table may be a bitmap and the method may further include updating the bitmap having bits corresponding to stripes if the corresponding stripe has been written. In yet a further example, the array of storage devices may be a RAID (redundant array of independent disk drives) system that utilizes parity for data redundancy. In one example, the storage devices may be solid state drives such as hard disk drives.

In one example, the XOR based parity initialization may include reading each bit in a stripe, except the parity bit, performing an XOR operation on the read bits to provide a result, and writing the result as the parity bit. The zero based parity initialization may include writing each bit in a stripe with a zero, including the parity bit using a write command to write the bits in parallel.

In a further example, performing write commands may include receiving a write command from a host, identifying a stripe that will be involved in performing the write command, determining if the identified stripe is being initialized, blocking the write command from being performed if the identified stripe is being initialized, and proceeding with the write command if the stripe is not being initialized. Multiple stripes may be combined into a zone, wherein the zone is treated as a stripe for initialization. A further example may include locking a stripe being written responsive to a write command from a host from initialization until the write is completed.

A controller for an array of storage devices that includes parity, the controller including a processor and a storage device coupled to the processor, the storage device having code for execution by the processor to perform a parity initialization method including determining if a stripe of the array has been written by checking a table stored on a storage device that indicates if the stripe has been written, performing an XOR based parity initialization of the stripe if the stripe has been written, and performing a zero based parity initialization of the stripe if the stripe has not been written.

In further embodiments, the controller may optionally include one or more of the following examples in various combinations. In one example, the method performed by the processor may include locking the stripe while performing parity initialization of the stripe and delaying write commands from a host until the parity initialization is complete. The table may be a bitmap having bits corresponding to stripes that is updated if the corresponding stripe has been written. In one example, the XOR based parity initialization comprises may include reading each bit in a stripe, except the parity bit, performing an XOR operation on the read bits to provide a result, and writing the result as the parity bit. The zero based parity initialization may include writing each bit in a stripe with a zero, including the parity bit using a write command to write the bits in parallel.

In a further example, the method performed by the processor may include performing write commands including receiving a write command from a host, identifying a stripe that will be involved in performing the write command, determining if the identified stripe is being initialized, blocking the write command from being performed if the identified stripe is being initialized, and proceeding with the write command if the stripe is not being initialized.

A machine readable storage device comprising instructions for execution by a processor of the machine to perform determining, via a controller of an array of storage devices that includes parity which has not been initialized, if a stripe of the array in use has been written by checking a table stored on a storage device that indicates if the stripe has been written, performing, via the controller, an XOR based parity initialization of the stripe if the stripe has been written, and performing, via the controller, a zero based parity initialization of the stripe if the stripe has not been written.

In further embodiments, the machine readable storage device may optionally include one or more of the following examples in various combinations. In one example, the table may be a bitmap and the machine may perform further operations including updating the bitmap having bits corresponding to stripes if the corresponding stripe has been written, checking the bitmap to determine if the stripe has been written, locking the stripe while performing parity initialization of the stripe, and delaying write commands from a host until the parity initialization is complete.

In a further example, the instructions for execution by the machine may cause the machine to perform write commands including receiving a write command from a host, identifying a stripe that will be involved in performing the write command, determining if the identified stripe is being initialized, blocking the write command from being performed if the identified stripe is being initialized, and proceeding with the write command if the stripe is not being initialized.

### BRIEF DESCRIPTION OF THE DRAWINGS

FIG. 1 is a block diagram of a system illustrating a host coupled storage device array having a hybrid parity initialization method according to an example embodiment.

FIG. 2 is a block diagram illustrating stripes of data on a storage device array with a bitmap indicative of stripes having been written according to an example embodiment.

FIG. 3 is a flowchart illustrating a method of combining foreground and background parity initialization according to an example embodiment.

FIG. 4 is a flowchart illustrating a method of processing write commands while initializing parity on an array of storage devices according to an example embodiment.

FIG. 5 is a block diagram illustrating circuitry for implementing devices to perform methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media or computer readable storage devices such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In various embodiments, background and foreground initialization of RAID (redundant array of inexpensive/independent disk drives) systems may be combined, which may provide for fast initialization while also providing for use of the RAID system during initialization.

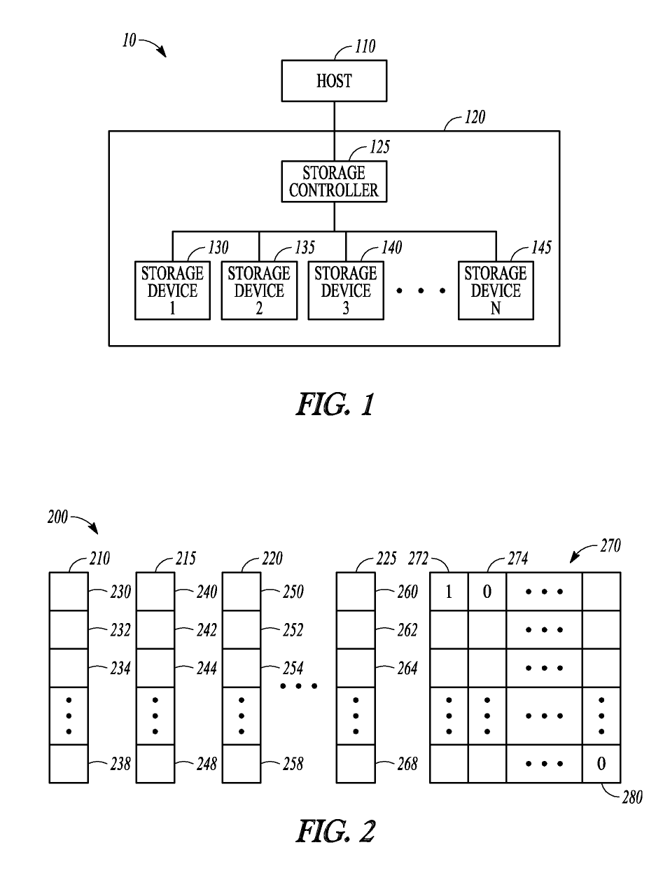

FIG. 1 is a block diagram of a system 100, illustrating a host 110 coupled to a RAID system 120 that includes a controller 125 that stores data on multiple storage devices, such as disk drives 130, 135, 140, 145. RAID system 120 may include parity information stored on one or more of the drives to insure that, if one drive fails, the data on that drive may be restored from the data, including parity data stored on the other drives. There are many different levels of RAID systems having varying degrees of redundancy and parity.

FIG. 2 is a block diagram illustrating striping of disk drives generally at 200 corresponding to an array of disk drives divided into blocks of data in stripes. RAID systems that include parity generally divide data into blocks, which may be at the bit level, byte level, page level, or any other desired quantity of data such as 512 bytes, 1024 bytes, larger powers of two, or other quantities. Different level RAID systems are currently standardized. For instance, RAID 2 utilizes bit level striping where each sequential bit is on a different drive with a parity bit stored on at least one parity drive. RAID 3 utilizes byte level striping. RAID 4-6 use block level striping.

Data blocks are illustrated for four drives 210, 215, 220, and 225 in FIG. 2, each with multiple stripes of data indicated at 230, 232, 234, and 238 for drive 210. Stripes 240, 242, 244, and 248 correspond to drive 215. Stripes 250, 252, 254, and 258 correspond to drive 220. Stripes 260, 262, 264, and 268 correspond to drive 225. One of the blocks in each stripe may include parity information, which in different RAID levels may be spread between drives.

Initialization of RAID systems that include parity is performed by the storage controller 125 in one embodiment to make parity information valid. Foreground initialization may be performed by simply writing zeroes to all the drives so that they all have the same values, overwriting any existing data in the process. Since parity is usually determined to make the sum of the bits even, parity is also set to zero via a method referred to as foreground initialization. In contrast, a background initialization method uses an XOR algorithm to initialize the parity information on the drives and does not rewrite existing data. All the bits in a stripe of bits across the drives, except for a parity bit, are read and provided to an XOR algorithm. The result is stored as the parity bit. The result is that the parity bit is set to ensure that the sum of all the bits is even via the use of XOR.

Although the RAID system may be used while it is being initialized in the background, initialization may slow I/O performance until completed. A rate of initialization may be selected to adjust how much it will slow performance. Initialization may also be delayed until a scheduled time.

In one embodiment, a table, which may be in the form of a bitmap 270 may be used by the controller to keep track of stripes that have been written by a host, such as host 110. The table may be any type of data structure from which a stripe may be identified and the written status of the stripe indicated. Bitmap 170 may contain one or more bits corresponding to each stripe in the array 200. The bits may be assigned sequentially in one embodiment such that a first bit 272 corresponds to a first stripe comprising blocks 230, 240, 250, and 260. While four drives are illustrated, as few as three, or more than four, may be used in various arrays. Note that the first bit 272 is a “1,” which may be indicative of the stripe having been written by the host. The next stripe comprising blocks 232, 242, 252, and 262 may be represented by the second bit 274 of the bitmap 270. The value of the second bit 274 is indicated as a “0,” indicative of the host not having used the second stripe. Finally, the last stripe comprising blocks 238, 248, 258, and 268 is represented by a last bit 280 of the bitmap, which also has a value of “0.”

The bitmap 270 in one embodiment may comprise a persistent memory, such as a non-volatile memory and may have a number of bits equal to or greater than the number of stripes in various embodiments. If a smaller bitmap is used, some stripes may not be represented by the bitmap. For unrepresented stripes, an XOR method may be defaulted to for initialization, or another method may be used to determine whether or not such stripes have been written, such as consulting a log or other buffer of write commands. In further embodiments, an external database or table may be used to track stripes, or the host may keep track if notified of stripe utilization by the controller. The bitmap 270 may be erased or otherwise discarded upon completion of the parity initialization.

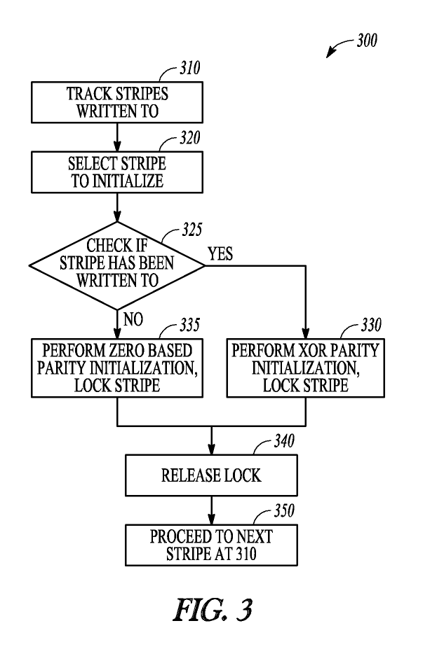

FIG. 3 is a flowchart illustrating a method 300 that combines background and foreground initialization. In various embodiments, the controller 125 may detect stripes which have not yet been written, and utilize the background method of simply writing zeros to such stripes. If stripes already have data written by the host, an XOR may be used to initialize such stripes. Thus, method 300 selects an initialization algorithm based on the state of the stripe. A bitmap may be used to keep track of which stripes have already been written by the host 110. The ability to detect stripes which have data and correspondingly use XOR to initialize parity for such stripes provide the ability to make volumes immediately when a RAID system is attached to the host and begin using the RAID system without delay.

Method 300 begins at 310 by using a bitmap to track stripes which have been written. As a write requested by the host is performed by the controller 125, the bitmap is created with at least one bit in the bitmap associated with each stripe. When the write request results in data being written to one or more stripes, the bitmap is updated to reflect the stripes that were written. Locking mechanisms may be used to avoid conflict between writes and initialization of parity bits.

At 320, a next stripe to initialize is selected. The selection may be sequential in one embodiment. The bitmap is checked to determine if the stripe has been written by the host. If the stripe has been written, XOR based parity initialization is performed at 330. If the stripe has not been written, zero based parity initialization is performed at 335. The stripe or stripes may be locked during initialization to avoid data corruption and released at 340 once initialization is complete. At 350, the next stripe may be proceeded to with processing returning to 310.

Since a stripe may be locked during initialization, a WRITE SAME SCSI (small computer system interface) parallel interface standard command may be used for background initialization to perform zero writing to maximize bandwidth utilization.

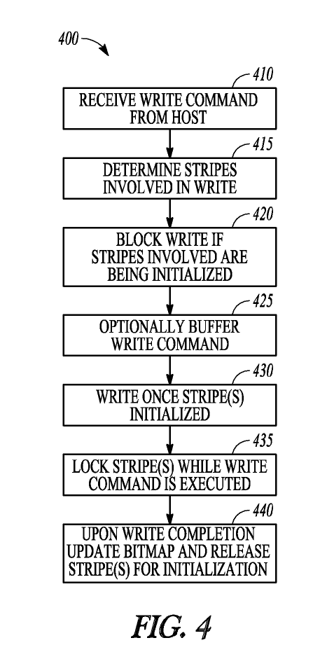

FIG. 4 is a flowchart illustrating a method 400 of processing write commands received by the controller. At 410, a write command is received from a host. The write command is processed by the controller at 415 to determine which stripes will be involved in the write. At 420, if a host write hits a stripe which is currently being initialized, the host write may be blocked until initialization is completed. At 425, the write command may be optionally buffered at the controller in one embodiment and written at 430 once the corresponding stripe or stripes have been initialized. While the write command is being performed, the affected stripe or stripes may be blocked from initialization at 435. Once the write command is completed, the bitmap may be updated at 440 and the stripe or stripes may be released for initialization.

In further embodiments, multiple stripes may be combined into a zone, with the bitmap being used to indicate which zone has been written by the host. This allows selection of a parity initialization algorithm on a zone by zone basis instead of per stripe. The WRITE SAME SCSI command for hard disk drive (HDD) based RAID systems, or a TRIM/UNMAP SCSI command for solid state drive (SSD) based RAID systems, may be used to write zeros to several stripes in parallel to further improve parity initialization speed. In some embodiments, about 96% of stripes may be initialized using the faster zero based parity initialization because few stripes are initially written when a RAID system is first coupled to the host.

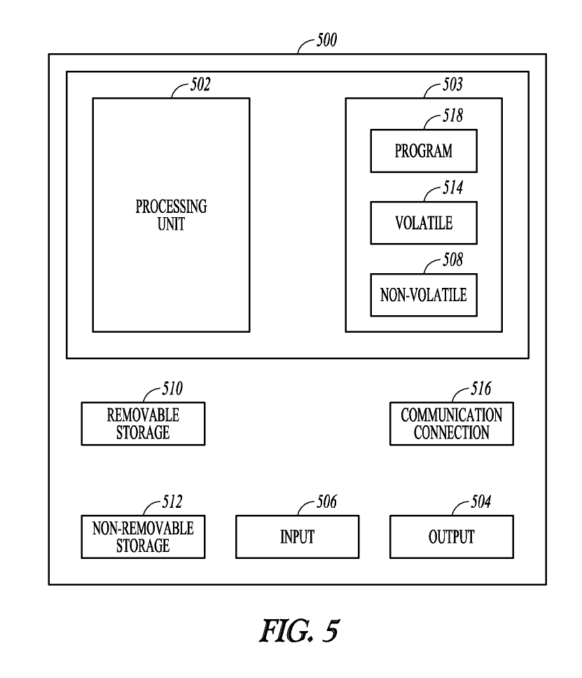

FIG. 5 is a block schematic diagram of a computer system 500 to implement the controller and methods according to example embodiments. All components need not be used in various embodiments. One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, or other computing device including the same or similar elements as illustrated and described with regard to FIG. 5. Devices such as smartphones, tablets, and smartwatches are generally collectively referred to as mobile devices. Further, although the various data storage elements are illustrated as part of the computer 500, the storage may also or alternatively include cloud-based storage accessible via a network, such as the Internet.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input 506, output 504, and a communication connection 516. Output 504 may include a display device, such as a touchscreen, that also may serve as an input device. The input 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 502 of the computer 500. A hard drive, CD-ROM, and RAM are some examples of articles including a non-transitory computer-readable medium, such as a storage device. The terms computer-readable medium and storage device do not include carrier waves. For example, a computer program 518 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 500 to provide generic access controls in a COM based computer network system having multiple users and servers.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
determining, via a controller of an array of storage devices that includes parity which has not been initialized, if a stripe of the array in use has been written by checking a table stored on a storage device that indicates if the stripe has been written;
performing, via the controller, an XOR based parity initialization of the stripe if the stripe has been written; and
performing, via the controller, a zero based parity initialization of the stripe if the stripe has not been written.

2. The method of claim 1 and further comprising:
locking the stripe while performing parity initialization of the stripe; and
delaying write commands from a host until the parity initialization is complete.

3. The method of claim 1 wherein the table comprises a bitmap, the method further comprising updating the bitmap having bits corresponding to stripes if the corresponding stripe has been written.

4. The method of claim 1 wherein the array of storage devices comprises a RAID (redundant array of independent disk drives) system that utilizes parity for data redundancy.

5. The method of claim 4 wherein the storage devices comprise solid state drives.

6. The method of claim 4 wherein the storage devices comprise hard disk drives.

7. The method of claim 1 wherein the XOR based parity initialization comprises:
reading each bit in a stripe, except the parity bit;
performing an XOR operation on the read bits to provide a result; and
writing the result as the parity bit.

8. The method of claim 1 wherein the zero based parity initialization comprises writing each bit in a stripe with a zero, including the parity bit using a write command to write the bits in parallel.

9. The method of claim 1 and further comprising performing write commands comprising:
receiving a write command from a host;
identifying a stripe that will be involved in performing the write command;
determining if the identified stripe is being initialized;
blocking the write command from being performed if the identified stripe is being initialized; and
proceeding with the write command if the stripe is not being initialized.

10. The method of claim 1 wherein multiple stripes are combined into a zone, wherein the zone is treated as a stripe for initialization.

11. The method of claim 1 and further comprising locking a stripe being written responsive to a write command from a host from initialization until the write is completed.

12. A controller for an array of storage devices that includes parity, the controller comprising:
a processor; and
a storage device coupled to the processor, the storage device having code for execution by the processor to perform a parity initialization method comprising:
determining if a stripe of the array has been written by checking a table stored on a storage device that indicates if the stripe has been written;
performing an XOR based parity initialization of the stripe if the stripe has been written; and
performing a zero based parity initialization of the stripe if the stripe has not been written.

13. The controller of claim 12 wherein the method performed by the processor further comprises:
locking the stripe while performing parity initialization of the stripe; and
delaying write commands from a host until the parity initialization is complete.

14. The controller of claim 12 wherein the table comprises a bitmap having bits corresponding to stripes that is updated if the corresponding stripe has been written.

15. The controller of claim 12 wherein the XOR based parity initialization comprises:
reading each bit in a stripe, except the parity bit;
performing an XOR operation on the read bits to provide a result; and
writing the result as the parity bit.

16. The controller of claim 12 wherein the zero based parity initialization comprises writing each bit in a stripe with a zero, including the parity bit using a write command to write the bits in parallel.

17. The controller of claim 12 wherein the method performed by the processor further comprises performing write commands comprising:
receiving a write command from a host;
identifying a stripe that will be involved in performing the write command;
determining if the identified stripe is being initialized;
blocking the write command from being performed if the identified stripe is being initialized; and
proceeding with the write command if the stripe is not being initialized.

18. A machine readable storage device comprising instructions for execution by a processor of the machine to perform:
determining, via a controller of an array of storage devices that includes parity which has not been initialized, if a stripe of the array in use has been written by checking a table stored on a storage device that indicates if the stripe has been written;
performing, via the controller, an XOR based parity initialization of the stripe if the stripe has been written; and
performing, via the controller, a zero based parity initialization of the stripe if the stripe has not been written.

19. The machine readable storage device of claim 18 wherein the table comprises a bitmap and wherein the machine further performs operations comprising:
updating the bitmap having bits corresponding to stripes if the corresponding stripe has been written;
checking the bitmap to determine if the stripe has been written;
locking the stripe while performing parity initialization of the stripe; and
delaying write commands from a host until the parity initialization is complete.

20. The machine readable storage device of claim 18 wherein the instructions for execution by the machine cause the machine to perform write commands comprising:
receiving a write command from a host;
identifying a stripe that will be involved in performing the write command;
determining if the identified stripe is being initialized;
blocking the write command from being performed if the identified stripe is being initialized; and
proceeding with the write command if the stripe is not being initialized.
